(19) United States
(12) Patent Application Publication
(10) Pub. No.: US 2021/0317648 A1
(43) Pub. Date: Oct. 14, 2021

(54) DEVICE FOR DEFECATION AND URINATION AND LAVATORY HAVING THE DEVICE

(71) Applicant: MU-YEN HSU, Yunlin County (TW)

(72) Inventor: MU-YEN HSU, Yunlin County (TW)

(21) Appl. No.: 17/203,769

(22) Filed: Mar. 17, 2021

(30) Foreign Application Priority Data
Apr. 9, 2020 (TW) 109111951

(51) Int. Cl. E03D 11/04; E03D 11/16

(52) U.S. Cl. CPC E03D 11/04; E03D 1/26; E03D 11/16

(57) ABSTRACT

A device for defecation and urination includes a bowl and a urinal. The bowl has a bottom channel. The bottom channel has a discharge hole. The urinal extends upward from one end of the bowl. The urinal has an upright channel in communication with the bottom channel. The device for defecation and urination operates ergonomically and cleanly and is suitable for use by any human being at any age. A lavatory which has the device for defecation and urination is further introduced.

### CROSS-REFERENCE TO RELATED APPLICATION

This non-provisional application claims priority under 35 U.S.C. § 119(a) on Patent Application No(s). 109111951 filed in Taiwan, R.O.C. on Apr. 9, 2020, the entire contents of which are hereby incorporated by reference.

### BACKGROUND OF THE INVENTION

### 1. Field of the Invention

The present disclosure relates to defecation and urination, and in particular to a device for defecation and urination and a lavatory having the device.

### 2. Description of the Related Art

Conventional facilities for defecation and urination include urinals and bowls and thus are not ergonomic when used by males. Urine streams discharged by male users who are old or sick are so weak that their parabolic paths fall outside urinals and bowls; thus, residues of urine are found all over the floor to the detriment of cleanliness. Furthermore, urinals and bowls are installed in a conventional lavatory to meet privacy need of males and females, albeit at the cost of taking up much space and adding to cost.

### BRIEF SUMMARY OF THE INVENTION

An objective of the present disclosure is to provide a device for defecation and urination.

To achieve at least the above objective, the present disclosure provides a device for defecation and urination, comprising a bowl having a bottom channel, the bottom channel having a discharge hole; and a urinal extending upward from an end of the bowl and having an upright channel, the upright channel being in communication with the bottom channel.

In an embodiment of the present disclosure, the bowl and the urinal are integrally formed.

In an embodiment of the present disclosure, the urinal has a water outlet disposed at an upper end of the upright channel.

In an embodiment of the present disclosure, the bowl is attached to a ground, and the discharge hole is disposed at a free end of the bottom channel.

In an embodiment of the present disclosure, the device for defecation and urination further comprises a supporter connected to two lateral edges of the urinal and thus is capable of rotating pivotally about the urinal.

In an embodiment of the present disclosure, the supporter comprises a rest and two connection elements, the two connection elements being disposed at a lower left of the rest and a lower right of the rest, respectively, and the connection elements connecting the urinal and the rest.

In an embodiment of the present disclosure, an elbow pushing portion is dispose at an upper left of the rest, and an elbow pushing portion is dispose at an upper right of the rest.

In an embodiment of the present disclosure, the bowl has a water outlet disposed at a junction of the bottom channel and the upright channel.

In an embodiment of the present disclosure, the bowl is disposed on a ground and has a height, and the discharge hole is disposed at a junction of the bottom channel and the upright channel.

In an embodiment of the present disclosure, the device for defecation and urination further comprises a supporter connected to the urinal and thus capable of rotating pivotally about the urinal.

In an embodiment of the present disclosure, the supporter comprises a ring, a lid and two connection elements, with the two connection elements disposed at left and right ends of the ring, respectively, and connecting the urinal and the ring.

The present disclosure further provides a lavatory, comprising: the device for defecation and urination, wherein the urinal is mounted on a wall, and the bowl is disposed on a ground; and a door member disposed at an edge of the wall, wherein a bottom height of the door member is greater than a height of the bowl.

In an embodiment of the present disclosure, the lavatory further comprises at least one handrail disposed beside the device for defecation and urination.

In an embodiment of the present disclosure, the urinal and the wall are integrally formed.

Therefore, according to the present disclosure, a device for defecation and urination comprises an upright channel and a bottom channel which are located at the parabolic path of a male's urine stream and thus can receive urine throughout the course of urination, ergonomically and cleanly. To poo (or pee), males (or females) squat, discharging feces (or urine) through a discharge hole of the bottom channel. The device for defecation and urination is suitable for use by any human being at any age. Therefore, a lavatory where the device for defecation and urination is installed does not require any urinals or bowls but is gender-neutral and cost-efficient.

### BRIEF DESCRIPTION OF THE DRAWINGS

FIG. 1 is a schematic perspective view of a device for defecation and urination according to the first embodiment of the present disclosure.

FIG. 2A is a schematic view of the device for defecation and urination in the first operation state according to the first embodiment of the present disclosure.

FIG. 2B is a schematic view of the device for defecation and urination in the second operation state according to the first embodiment of the present disclosure.

FIG. 3 is a schematic view of a supporter according to the first embodiment of the present disclosure.

FIG. 4 is a schematic perspective view of a device for defecation and urination according to the second embodiment of the present disclosure.

FIG. 5A is a schematic view of the device for defecation and urination in the first operation state according to the second embodiment of the present disclosure.

FIG. 5B is a schematic view of the device for defecation and urination in the second operation state according to the second embodiment of the present disclosure.

FIG. 6 is a schematic view of a lavatory according to the third embodiment of the present disclosure.

FIG. 7 is a schematic view of a lavatory according to the fourth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

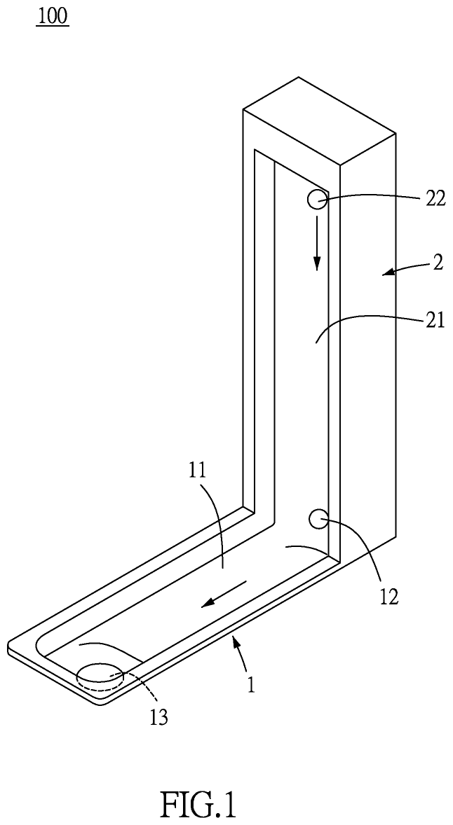

Referring to FIG. 1, the first embodiment of the present disclosure provides a device 100 for defecation and urination, comprising a bowl 1 and a urinal 2.

The bowl 1 has a bottom channel 11. The bottom channel 11 has a discharge hole 13.

The urinal 2 extends upward from one end of the bowl 1. The urinal 2 has an upright channel 21. The upright channel 21 is in communication with the bottom channel 11. In a variant embodiment, the urinal 2 is made of surface-treated ceramic, but the present disclosure is not limited thereto.

To pee, males face the urinal 2 while standing. Both the upright channel 21 and bottom channel 11 are located at the parabolic path of a urine stream and thus can receive urine throughout the course of urination, ergonomically and cleanly. To poo (or pee), males (or females) squat while facing (or preferably facing away, for reasons explained later) the urinal 2. Both the feces and urine are discharged via the discharge hole 13. The device 100 for defecation and urination is suitable for use by any human being at any age. Therefore, a lavatory where the device 100 for defecation and urination is installed does not require any urinals or bowls but is gender-neutral and cost-efficient.

In this embodiment, the bowl 1 and the urinal 2 are integrally formed, and the urinal 2 is mounted on a wall (not shown).

In this embodiment, as shown in FIG. 1, the urinal 2 has a water outlet 22 disposed at the upper end of the upright channel 21. The water outlet 22 is connected to a flushing pipe to flush the upright channel 21, thereby keeping the upright channel 21 clean.

In this embodiment, as shown in FIG. 1, the discharge hole 13 is disposed at the free end of the bottom channel 11, whereas the bowl 1 has a water outlet 12 disposed at the junction of the bottom channel 11 and the upright channel 21. The water outlet 12 is connected to a flushing pipe to flush the bottom channel 11 harder, thereby keeping the bottom channel 11 clean.

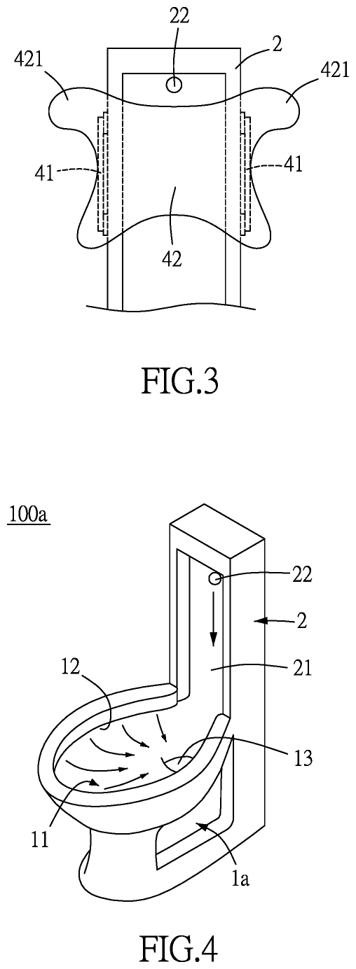

In this embodiment, as shown in 2A through FIG. 3, the device 100 for defecation and urination further comprises a supporter 4 connected to two lateral edges of the urinal 2. In this embodiment, the supporter 4 is pivotally connected and thus is capable of rotating pivotally about the urinal 2.

The supporter 4 is a backrest or handrail, but the present disclosure is not limited thereto. In this embodiment, the supporter 4 comprises a rest 42 and two connection elements 41. The two connection elements 41 are disposed at the lower left of the rest 42 and the lower right of the rest 42, respectively. The connection elements 41 connect the urinal 2 and the rest 42. In this embodiment, the connection elements 41 are pivotally connected to the urinal 2 and the rest 42. To pee while squatting, a user lays down the rest 42 and then rests her body against the rest 42 while facing away from the urinal 4. To pee while standing, a user lifts the rest 42 and pees. However, the present disclosure is not limited thereto, as the supporter 4 can be of any other shape and structure and can have any other means for connecting to the urinal 2.

In this embodiment, as shown in FIG. 3, the supporter 4 is made of plastic. An elbow pushing portion 421 is disposed at the upper left of the rest 42. An elbow pushing portion 421 is disposed at the upper right of the rest 42. The elbow pushing portions 421 each have a curved surface structure. Users use their elbows to push the lower curved surface of any one of the elbow pushing portions 421 in order to lift the elbow pushing portion 421. Alternatively, users use their elbows to press on the upper curved surface of any one of the elbow pushing portions 421 in order to move the elbow pushing portion 421 downward slightly. Therefore, the supporter 4 is moved not by hand and thus is clean.

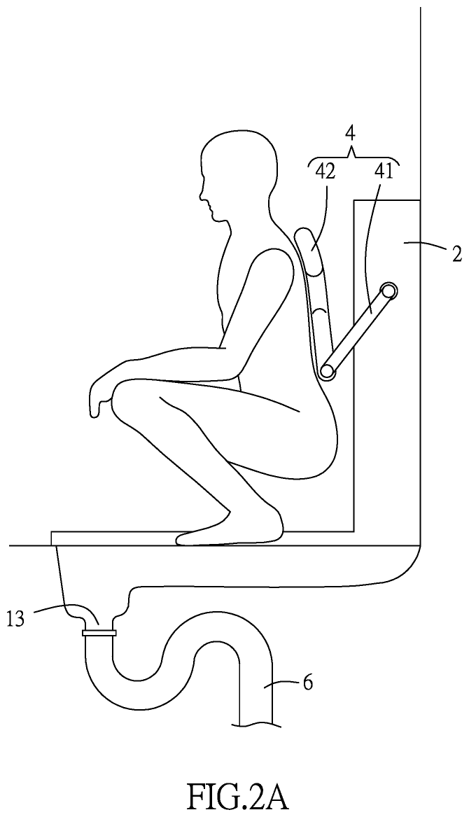

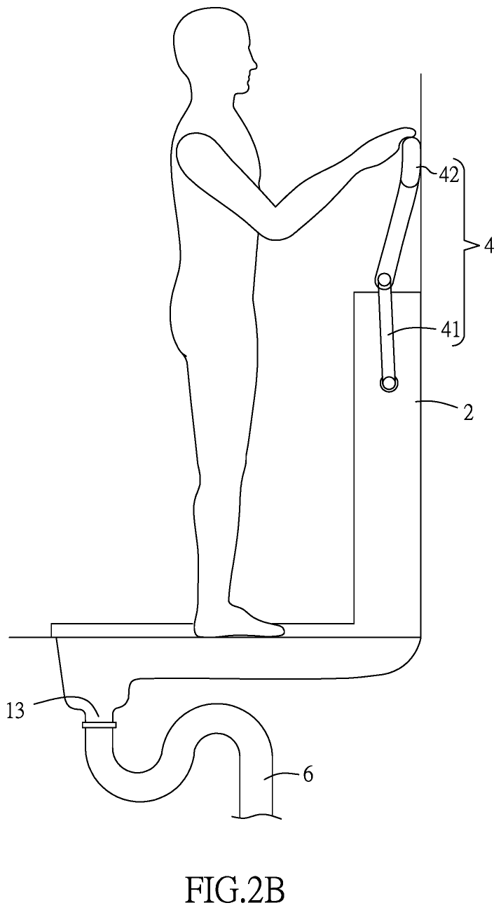

In this embodiment, as shown in FIG. 2A and FIG. 2B, the device 100 for defecation and urination further comprises a discharge pipe 6 in communication with the discharge hole 13. The discharge pipe 6 is S-shaped and has a middle liquid-storing segment for preventing intrusion of stenches from the other end of the discharge pipe 6.

Referring to FIG. 4, in the second embodiment of the present disclosure, the device 100a for defecation and urination comprises a bowl 1a and a urinal 2. The bowl 1a has the bottom channel 11. The urinal 2 extends upward from one end of the bowl 1a. The urinal 2 has the upright channel 21. The upright channel 21 is in communication with the bottom channel 11. The urinal 2 has a water outlet 22 disposed at the upper end of the upright channel 21. The water outlet 22 is connected to a flushing pipe to flush the upright channel 21, thereby keeping the upright channel 21 clean.

The device 100a for defecation and urination in the second embodiment is distinguished from the device 100 for defecation and urination in the first embodiment by technical features as follows: in the second embodiment, the bowl 1a is disposed on the ground and thus has a specific height (i.e., the height of a conventional seat bowl); and the discharge hole 13 of the bowl 1a is disposed at the junction of the bottom channel 11 and the upright channel 21. The bowl 1a also has a water outlet (not shown) disposed around the bowl 1a, such that water released from the water outlet flows downward across the inner wall of the bowl 1a to flush the bowl 1a. In this embodiment, males stand to pee but sit to poo, whereas females sit to pee.

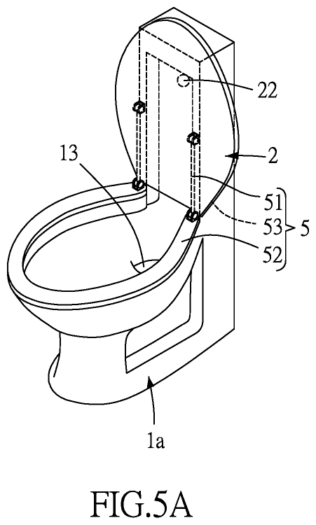

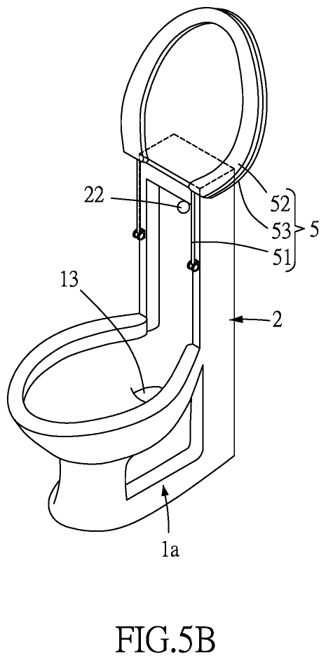

In this embodiment, as shown in FIG. 5A and FIG. 5B, the device 100a for defecation and urination further comprises a supporter 5 connected to the urinal 2 and thus is capable of rotating pivotally about the urinal 2. In this embodiment, the supporter 5 and the urinal 2 are pivotally connected.

In this embodiment, the supporter 5 is a bowl ring for underpinning a user's buttocks and thighs. The supporter 5 comprises a ring 52, a lid 53 and two connection elements 51. The two connection elements 51 are disposed at left and right ends of the ring 52, respectively. The connection elements 51 connect the urinal 2 and the ring 52. The lid 53 is also connected to the connection elements 51. In this embodiment, the connection elements 51, ring 52 and lid 53 are pivotally connected to each other. Every person can lay the ring 52 and then sit on the ring 52 to pee or poo. Males lift the ring 52 in order to pee while standing still. When the device 100a for defecation and urination is not in use, the lid 53 may be laid down to hide the bowl 1a. However, the present disclosure is not limited thereto, as the supporter 5 can be of any other shape and structure and can have any other means for connecting to the urinal 2.

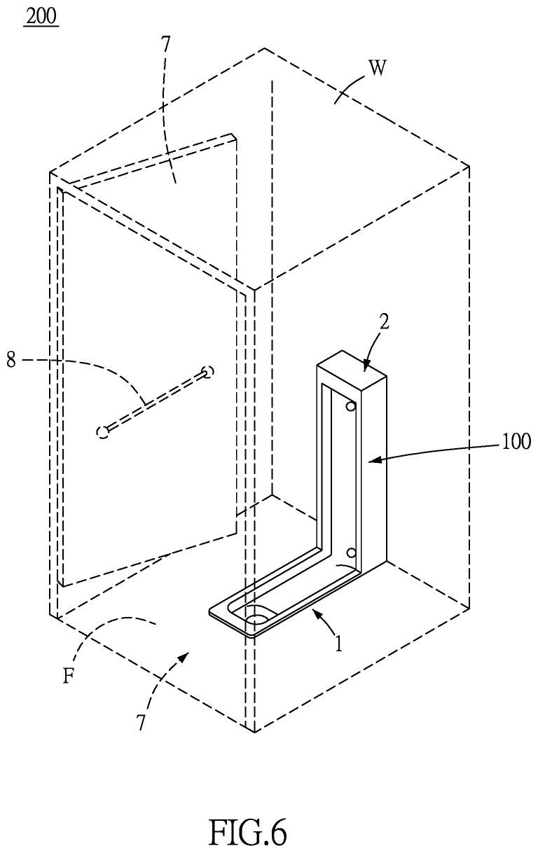

Referring to FIG. 6, the third embodiment of the present disclosure further provides a lavatory 200 which comprises the device 100, 100a for defecation and urination (for example, the device 100 for defecation and urination, as shown in FIG. 6) and a door member 7.

The urinal 2 of the device 100 for defecation and urination is mounted on a wall W of the lavatory 200. The bowl 1 of the device 100 for defecation and urination is disposed on a ground F of the lavatory 200.

The door member 7 is disposed at one edge of the wall W. The bottom height of the door member 7 is greater than the height of the bowl 1.

The lavatory 200 not only has the aforesaid advantages of the device 100, 100a for defecation and urination, but the door member 7 is opened inward to thereby take up less space than conventional lavatories.

In this embodiment, the lavatory 200 further comprises at least one handrail 8 disposed beside the device 100 for defecation and urination and adapted to be gripped by users while the users are peeing or pooing.

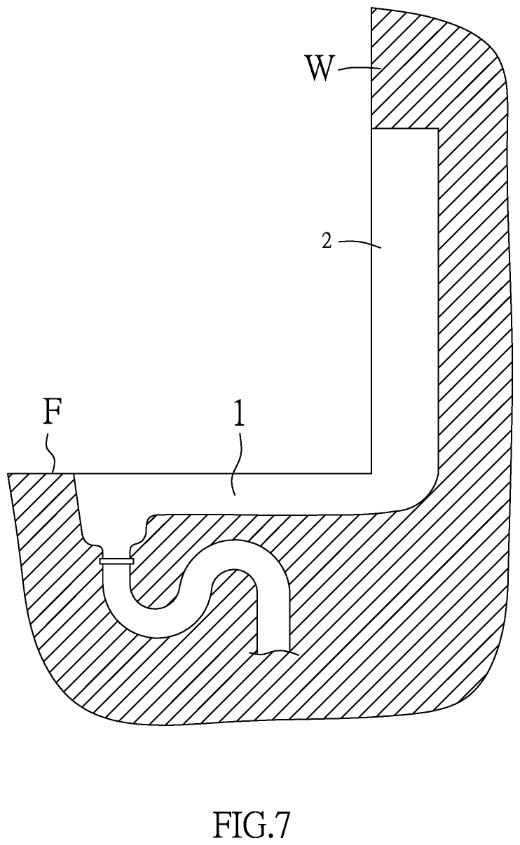

Referring to FIG. 7, in the fourth embodiment of the present disclosure, the urinal 2 and wall W are integrally formed, or the urinal 2 is embedded in the wall W. Similarly, the bowl 1 and the ground F are integrally formed, or the bowl 1 is embedded in the ground F. However, the present disclosure is not limited thereto.

While the present disclosure has been described by means of specific embodiments, numerous modifications and variations could be made thereto by those skilled in the art without departing from the scope and spirit of the present disclosure set forth in the claims.

What is claimed is:

1. A device for defecation and urination, comprising:
a bowl having a bottom channel, the bottom channel having a discharge hole; and
a urinal extending upward from an end of the bowl and having an upright channel, the upright channel being in communication with the bottom channel.

2. The device for defecation and urination according to claim 1, wherein the bowl and the urinal are integrally formed.

3. The device for defecation and urination according to claim 1, wherein the urinal has a water outlet disposed at an upper end of the upright channel.

4. The device for defecation and urination according to claim 1, wherein the bowl is attached to a ground, and the discharge hole is disposed at a free end of the bottom channel.

5. The device for defecation and urination according to claim 4, further comprising a supporter connected to two lateral edges of the urinal and thus is capable of rotating pivotally about the urinal.

6. The device for defecation and urination according to claim 5, wherein the supporter comprises a rest and two connection elements, the two connection elements being disposed at a lower left of the rest and a lower right of the rest, respectively, and the connection elements connecting the urinal and the rest.

7. The device for defecation and urination according to claim 6, wherein an elbow pushing portion is dispose at an upper left of the rest, and an elbow pushing portion is dispose at an upper right of the rest.

8. The device for defecation and urination according to claim 4, wherein the bowl has a water outlet disposed at a junction of the bottom channel and the upright channel.

9. The device for defecation and urination according to claim 1, wherein the bowl is disposed on a ground and has a height, and the discharge hole is disposed at a junction of the bottom channel and the upright channel.

10. The device for defecation and urination according to claim 9, further comprising a supporter connected to the urinal and thus capable of rotating pivotally about the urinal.

11. The device for defecation and urination according to claim 10, wherein the supporter comprises a ring, a lid and two connection elements, with the two connection elements disposed at left and right ends of the ring, respectively, and connecting the urinal and the ring.

12. A lavatory, comprising:
the device for defecation and urination according to claim 1, wherein the urinal is mounted on a wall, and the bowl is disposed on a ground; and
a door member disposed at an edge of the wall, wherein a bottom height of the door member is greater than a height of the bowl.

13. The lavatory of claim 12, further comprising at least one handrail disposed beside the device for defecation and urination.

14. The lavatory of claim 12, wherein the urinal and the wall are integrally formed.
